(19) United States
(12) Patent Application Publication
(10) Pub. No.: US 2012/0019104 A1
(43) Pub. Date: Jan. 26, 2012

(54) TRANSDUCER AND ULTRASONIC MOTOR

(75) Inventor: Katsuhiko YOSHIMURA, Koganei-shi (JP)

(73) Assignee: OLYMPUS CORPORATION, Tokyo (JP)

(21) Appl. No.: 13/185,600

(22) Filed: Jul. 19, 2011

(30) Foreign Application Priority Data
Jul. 23, 2010 (JP) 2010-166251

(51) Int. Cl. H02N 2/04

(52) U.S. Cl. 310/323.16

(57) ABSTRACT

According to one embodiment, a transducer includes, a first transducer member, a second transducer member, and a coupling member. The first transducer member including a piezoelectric element in which longitudinal vibration and bending vibration are excited by application of a predetermined alternating signal. The second transducer member which is placed to make a predetermined angle with the first transducer member and in which longitudinal vibration and bending vibration are excited by application of a predetermined alternating signal. The coupling member configured to hold one end of the first transducer member and one end of the second transducer member.

### CROSS-REFERENCE TO RELATED APPLICATIONS

This application is based upon and claims the benefit of priority from prior Japanese Patent Application No. 2010-166251, filed Jul. 23, 2010, the entire contents of which are incorporated herein by reference.

### BACKGROUND OF THE INVENTION

1. Field of the Invention

The present invention relates to a transducer such as a piezoelectric element, and an ultrasonic motor including the transducer.

2. Description of the Related Art

Recently, attention has been paid to an ultrasonic motor using the vibration of a transducer such as a piezoelectric element as a new motor replacing an electromagnetic type motor. This ultrasonic motor is superior to a conventional electromagnetic type motor in low-speed high thrust without gears, high holding force, high resolution, low noise, no magnetic noise, and the like. More specifically, there is known an ultrasonic motor which excites elliptic vibration in a transducer by applying a predetermined alternating voltage to it, and frictionally drives a driven member by using the elliptic vibration as a driving source.

As a technique associated with such an ultrasonic motor, for example, the following technique is disclosed in Jpn. Pat. Appln. KOKAI Publication No. 5-146171. That is, Jpn. Pat. Appln. KOKAI Publication No. 5-146171 discloses an ultrasonic transducer formed by joining a first multilayer member (to be referred to as a bending vibration multilayer member hereinafter), formed by alternately stacking first and second stacked members, in series with a second multilayer member (to be referred to as a stretching vibration multilayer member hereinafter), formed by stacking a plurality of piezoelectric elements each having inner electrodes on its two surfaces, in the stacking direction.

In this case, the first stacked member is a member formed by stacking two piezoelectric elements, obtained by dividing an internal electrode on one of two surfaces on which internal electrodes are formed into two parts, so as to make the divided surfaces of the internal electrodes face each other. The second stacked member is a member formed by stacking two piezoelectric elements, obtained by dividing an internal electrode on one of two surfaces on which internal electrodes are formed into two parts in a direction perpendicular to the above dividing direction, so as to make the divided surfaces of the internal electrodes face each other. External electrodes for electrically connecting the internal electrodes are formed on the outer surface of the ultrasonic transducer.

The ultrasonic transducer disclosed in Jpn. Pat. Appln. KOKAI Publication No. 5-146171 has the above structure, and outputs elliptic vibration by combining the vibration of the bending vibration multilayer member with the vibration of the stretching vibration multilayer member.

Installation spaces for ultrasonic motors vary in shape and size depending on the applications of products in which the ultrasonic motors are to be mounted. More specifically, the installation space of an ultrasonic motor may be a small flat space. As described above, various restrictions are imposed on installation spaces for ultrasonic motors, and hence the ultrasonic motors need to be reduced in size to increase their versatility.

Note that the ultrasonic transducer disclosed in Jpn. Pat. Appln. KOKAI Publication No. 5-146171 has a certain thickness in the stacking direction, and hence some limitations are imposed on products (applications) in which the transducer is to be mounted.

### BRIEF SUMMARY OF THE INVENTION

The present invention has been made in consideration of the above situations, and has as its object to provide a transducer and an ultrasonic motor which has a shape and size that impose light restrictions on installation spaces.

To achieve the above object, according to an aspect of the present invention, there is provided a transducer comprising:

a first transducer member including a piezoelectric element in which longitudinal vibration and bending vibration are excited by application of a predetermined alternating signal;

a second transducer member which is placed to make a predetermined angle with the first transducer member and in which longitudinal vibration and bending vibration are excited by application of a predetermined alternating signal; and

a coupling member configured to hold one end of the first transducer member in a longitudinal direction and one end of the second transducer member in a longitudinal direction.

The prevent invention can provide a transducer and an ultrasonic motor which has a shape and size that impose light restrictions on installation spaces.

Advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing an example of the arrangement of an ultrasonic motor including a transducer according to an embodiment of the present invention;

FIG. 2 is a perspective view showing an example of the arrangement of a transducer according to an embodiment of the present invention and the directions of elliptic vibration excited in the transducer;

FIG. 3 is a perspective view showing an example of the arrangement of a transducer;

FIG. 4 is a perspective view showing an example of the arrangement of a transducer;

FIG. 5 is a perspective view showing an example of the arrangement of a transducer;

FIG. 6 is a perspective view showing an example of the arrangement of a transducer;

FIG. 7 is a perspective view showing how a driven member is actually driven by <<Driving Method 1>> and <<Driving Method 4>>;

FIG. 8 is a perspective view showing how a driven member is actually driven by <<Driving Method 2>> and <<Driving Method 3>>;

FIG. 9 is a perspective view showing an example of the arrangement of an ultrasonic motor including a transducer according to a modification and a driving direction;

FIG. 10 is a perspective view showing an example of the arrangement of an ultrasonic motor including a transducer according to a modification and a driving direction;

FIG. 11 is a perspective view showing an example of the arrangement of an ultrasonic motor including a transducer according to a modification and a driving direction; and

FIG. 12 is a perspective view showing an example of the arrangement of an ultrasonic motor including a transducer according to a modification and a driving direction.

### DETAILED DESCRIPTION OF THE INVENTION

An embodiment of the present invention will be described below with reference to the views of the accompanying drawing.

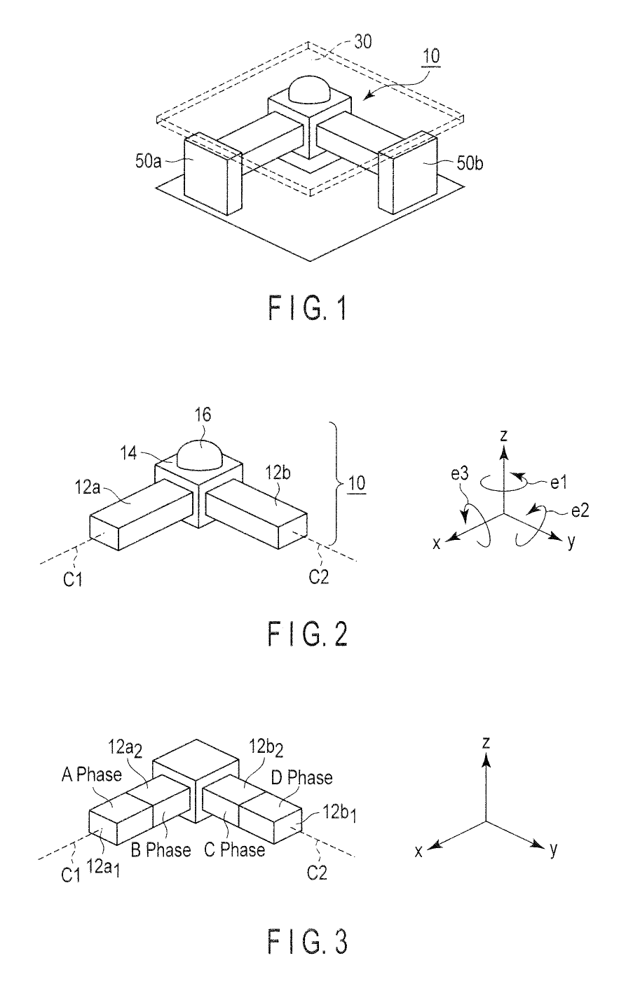

FIG. 1 is a perspective view showing an example of the arrangement of an ultrasonic motor including a transducer according to an embodiment of the present invention. FIG. 2 is a perspective view showing an example of the arrangement of a transducer according to an embodiment of the present invention and the directions of elliptic vibration excited in the transducer.

As shown in FIG. 1, an ultrasonic motor according to the first embodiment includes a transducer 10 according to an embodiment, a driven member 30, and fixing members 50a and 50b.

The transducer 10 includes two piezoelectric bodies 12a and 12b, a coupling member 14 to which one end of each of the two piezoelectric bodies 12a and 12b in a longitudinal direction is coupled, and a friction member 16 which frictionally drives the driven member 30. Note that another part of each of the two piezoelectric bodies 12a and 12b may be coupled to the coupling member 14, in stead of the one end in the longitudinal direction.

As shown in FIG. 2, the piezoelectric body 12a is placed along the x-axis and has one end coupled to the coupling member 14. The piezoelectric body 12b is placed along the y-axis perpendicular to the x-axis and has one end coupled to the coupling member 14, as shown in FIG. 2.

More specifically, the piezoelectric bodies 12a and 12b of the transducer 10 are coupled to each other through the coupling member 14 such that a center axis C1 of the piezoelectric body 12a makes a right angle with (is perpendicular to) a center axis C2 of the piezoelectric body 12b. In this case, the center axes C1 and C2 of the piezoelectric bodies 12a and 12b are axes each extending through the centers of the two end faces of each of the piezoelectric bodies 12a and 12b in the longitudinal direction.

Note that if the center axes C1 and C2 of the piezoelectric bodies 12a and 12b are not flush with each other, the piezoelectric bodies 12a and 12b are configured such that a projection of the center axis C1 of the piezoelectric body 12a on an x-y plane makes a right angle with (is perpendicular to) a projection of the center axis C2 of the piezoelectric body 12b on the x-y plane.

The arrangement in which the center axis C1 of the piezoelectric body 12a makes a right angle with (is perpendicular to) the center axis C2 of the piezoelectric body 12b at the coupling member 14 is a preferred arrangement from the viewpoint of easiness of driving control. However, this is not an essential arrangement. In other words, the center axis C1 may make an arbitrary angle with the center axis C2.

For the sake of descriptive convenience, this embodiment will exemplify an arrangement in which the center axis C1 of the piezoelectric body 12a makes a right angle with (is perpendicular to) the center axis C2 of the piezoelectric body 12b at the coupling member 14.

FIGS. 3, 4, 5, and 6 each show an example of the arrangement of the piezoelectric bodies 12a and 12b. The arrangement of the piezoelectric bodies 12a and 12b will be described in detail below.

In the example shown in FIG. 3, the piezoelectric body 12a is formed by bonding piezoelectric bodies 12a1 and 12a2 in the center axis C1 direction (x-axis direction). Likewise, the piezoelectric body 12b is formed by bonding piezoelectric bodies 12b1 and 12b2 in the center axis C2 direction (y-axis direction).

Note that the piezoelectric bodies 12a1 and 12a2 have shapes obtained by dividing the piezoelectric body 12a into two equal parts in the center axis C1 direction (x-axis direction). Likewise, the piezoelectric bodies 12b1 and 12b2 have shapes obtained by dividing the piezoelectric body 12b into two equal parts in the center axis C2 direction (y-axis direction).

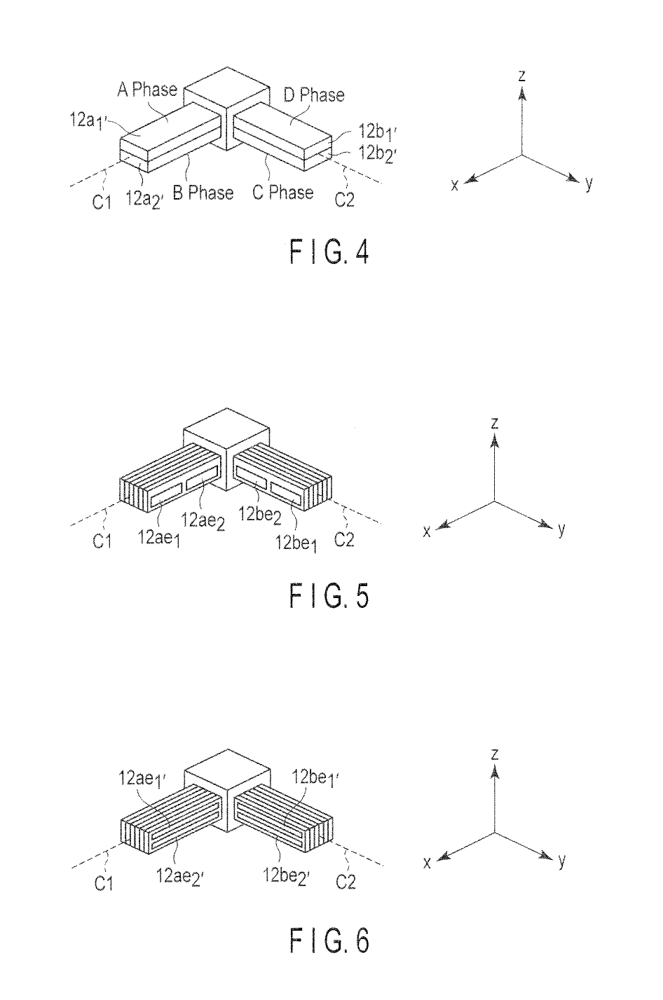

In the example shown in FIG. 4, the piezoelectric body 12a is formed by bonding piezoelectric bodies 12a1′ and 12a2′ in a direction (z-axis direction) perpendicular to the center axis C1 direction. Likewise, the piezoelectric body 12b is formed by bonding piezoelectric bodies 12b1′ and 12b2′ in a direction (z-axis direction) perpendicular to the center axis C2 direction.

Note that the piezoelectric bodies 12a1′ and 12a2′ have shapes obtained by dividing the piezoelectric body 12a into two equal parts in a direction (z-axis direction) perpendicular to an x-y plane. Likewise, the piezoelectric bodies 12b1′ and 12b2′ have shapes obtained by dividing the piezoelectric body 12b into two equal parts in a direction (z-axis direction) perpendicular to the x-y plane.

In the example shown in FIG. 5, the piezoelectric body 12a is formed by stacking a plurality of piezoelectric elements in the y-axis direction (has a multilayer structure), and internal electrodes 12ae1 and 12ae2 are arranged side by side in the center axis C1 direction (x-axis direction) on each of the plurality of piezoelectric elements. Likewise, the piezoelectric body 12b is formed by stacking a plurality of piezoelectric elements in the x-axis direction (has a multilayer structure), and internal electrodes 12be1 and 12be2 are arranged side by side in the center axis C2 direction (y-axis direction) on each of the plurality of piezoelectric elements.

In the example shown in FIG. 6, the piezoelectric body 12a is formed by stacking a plurality of piezoelectric elements in the y-axis direction (has a multilayer structure), and internal electrodes 12ae1′ and 12ae2′ are arranged side by side in a direction (z-axis direction) perpendicular to the center axis C1 direction on each of the plurality of piezoelectric elements. Likewise, the piezoelectric body 12b is formed by stacking a plurality of piezoelectric elements in the x-axis direction (has a multilayer structure), and internal electrodes 12be1′ and 12be2′ are arranged side by side in a direction (z-axis direction) perpendicular to the center axis C2 direction on each of the plurality of piezoelectric elements.

Note that the sizes of the piezoelectric bodies 12a and 12b may be properly set so as to allow to excite elliptic vibration in the coupling member 14. In addition, the order of the vibration mode to be used for driving is decided, and the longitudinal effect or lateral effect of each piezoelectric body is selected to be used for driving. In accordance with the selection results, proper electrodes are provided on the piezoelectric bodies 12a and 12b, and signal lines for inputting driving signals are extracted from the electrodes. Note that the piezoelectric bodies 12a1, 12a2, 12b1, and 12b2 shown in FIGS. 3 each may have a multilayer structure. Similarly the piezoelectric bodies 12a1′, 12a2′, 12b1′, and 12b2′ shown in FIGS. 4 each may have a multilayer structure. In addition, obviously, piezoelectric bodies may be bonded to each other through elastic bodies.

The coupling member 14 holds one end of each of the piezoelectric bodies 12a and 12b and holds the above positional relationship between the piezoelectric bodies 12a and 12b.

The friction member 16 is a member provided on the coupling member 14 so as to come into contact with the driven member 30, and frictionally drives the driven member 30 by using the elliptic vibration excited in the transducer 10 as a driving source.

Note that the friction member 16 is not an essential constituent element, and the coupling member 14 may frictionally drive the driven member 30 by itself. Alternatively, the friction member 16 may be provided on an end face of one of the piezoelectric bodies 12a and 12b.

The fixing members 50a and 50b are members each configured to fix one end of a corresponding one of the piezoelectric bodies 12a and 12b which is not coupled to the coupling member 14. This arrangement allows to use the elliptic vibration excited in the coupling member 14 for driving (to transfer the elliptic vibration to the driven member 30).

A method of driving the ultrasonic motor including the transducer according to this embodiment will be described below.

The piezoelectric bodies 12a1, 12a1′, 12a2, 12a2′, 12b1, 12b1′, 12b2, and 12b2′ each are provided with a vibration excitation unit (not shown, ditto for the following) for inputting an alternating signal as a driving signal. In this embodiment, the vibration excitation units of the respective piezoelectric bodies will be referred to as follows:
The vibration excitation unit of the piezoelectric body 12a1 (12a1′) will be referred to as an A-phase vibration excitation unit.
The vibration excitation unit of the piezoelectric body 12a2 (12a2′) will be referred to as a B-phase vibration excitation unit.
The vibration excitation unit of the piezoelectric body 12b1 (12b1′) will be referred to as a C-phase vibration excitation unit.
The vibration excitation unit of the piezoelectric body 12b2 (12b2′) will be referred to as a D-phase vibration excitation unit.

It is possible to excite elliptic vibration in the transducer 10 by applying alternating signals with the following phase differences to the vibration excitation units of the respective phases while using one of the A-phase, B-phase, C-phase, and D-phase vibration excitation units as a reference vibration excitation unit. The following shows driving method examples:

### <<Driving Method 1>> Driving by Elliptic Vibration

Indicated by Arrow e1 in FIG. 2 (Elliptic Vibration around Z-axis):
A phase: reference, B phase: phase difference of 0°,
C phase: phase difference of 90°, D phase: phase difference of 90°

### <<Driving Method 2>> Driving by Elliptic Vibration

Indicated by Arrow e2 in FIG. 2 (Elliptic Vibration around Y-axis):
A phase: reference, B phase: phase difference of 90°, C phase: not used, D phase: not used

### <<Driving Method 3>> Driving by Elliptic Vibration

Indicated by Arrow e3 in FIG. 2 (Elliptic Vibration around X-axis):
A phase: not used, B phase: not used, C phase: reference, D phase: phase difference of 90°
   <<Driving Method 4>> Driving by Elliptic Vibration in Plane Satisfying x=y:
A phase: reference, B phase: phase difference of 90°, C phase: phase difference of 0°, D phase: phase difference of 90°

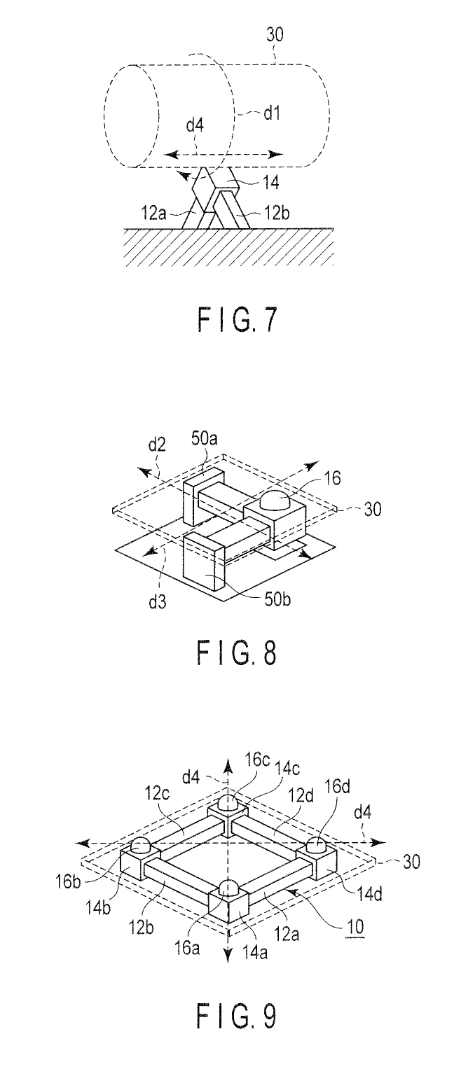

Using each <<Driving Method>> can drive the driven member 30, for example, in the following manner. FIGS. 7 and 8 show an actual example of driving the driven member 30 by using <<Driving Method 1>> to <<Driving Method 4>>.

The direction indicated by an arrow d1 in FIG. 7 is the driving direction of the driven member 30 based on <<Driving Method 1>> described above (the direction of driving by elliptic vibration around the z-axis). The direction indicated by an arrow d4 in FIG. 7 is the driving direction of the driven member 30 based on <<Driving Method 4>> described above (the direction of driving by elliptic vibration in a plane satisfying x=y).

The direction indicated by an arrow d2 in FIG. 8 is the driving direction of the driven member 30 based on <<Driving Method 2>> described above (the direction of driving by elliptic vibration around the y-axis), The direction indicated by an arrow d3 in FIG. 8 is the driving direction of the driven member 30 based on <<Driving Method 3>> described above (the direction of driving by elliptic vibration around the x-axis).

Note that the fixing members 50a and 50b are not necessarily essential constituent elements. If, for example, the fixing member 50b is not provided, it is possible to use, for driving, elliptic vibration excited in one end face of the piezoelectric body 12b which is not coupled to the coupling member 14.

As described above, this embodiment can provide a transducer which has a shape and size that impose light restrictions on installation spaces. More specifically, the transducer and ultrasonic motor according to this embodiment can obtain, for example, the following effects:
The transducer and motor can drive the driven member 30 in many directions, and have shapes and sizes that allow installation even in a flat space.
It is possible to design an ultrasonic motor which fits in an installation space on which severe restrictions are imposed in terms of the size of the space.
It is possible to achieve a reduction in profile as well as implementing multiple degrees of freedom, that is, being capable of driving in two or more directions.
That is, it is possible to simultaneously achieve both an increase in the number of functions and a decrease in size.

The embodiment described above can be variously modified. For example, it is possible to provide modifications like those shown in FIGS, 9, 10, 11, and 12. FIGS. 9, 10, 11, and 12 are perspective views each showing an example of the arrangement of an ultrasonic motor including a transducer according to a modification of the embodiment described above and a driving direction.

The transducer 10 shown in FIG. 9 includes four piezoelectric bodies 12a, 12b, 12c, and 12d, four coupling members 14a, 14b, 14c, and 14d, and four friction members 16a, 16b, 16c, and 16d.

More specifically, the respective pairs of piezoelectric bodies (the piezoelectric bodies 12a and 12b, the piezoelectric bodies 12b and 12c, the piezoelectric bodies 12c and 12d, and the piezoelectric bodies 12d and 12a) are respectively coupled by the coupling members 14a, 14b, 14c, and 14d such that the center axes of the respective piezoelectric bodies make right angles with each other (perpendicular to each other). When viewed from above, the overall transducer 10 has a hollow square shape. The direction indicated by an arrow d4 in FIG. 9 is the driving direction of the driven member 30 based on <<Driving Method 4>> described above (the direction of driving by elliptic vibration in a plane satisfying x=y).

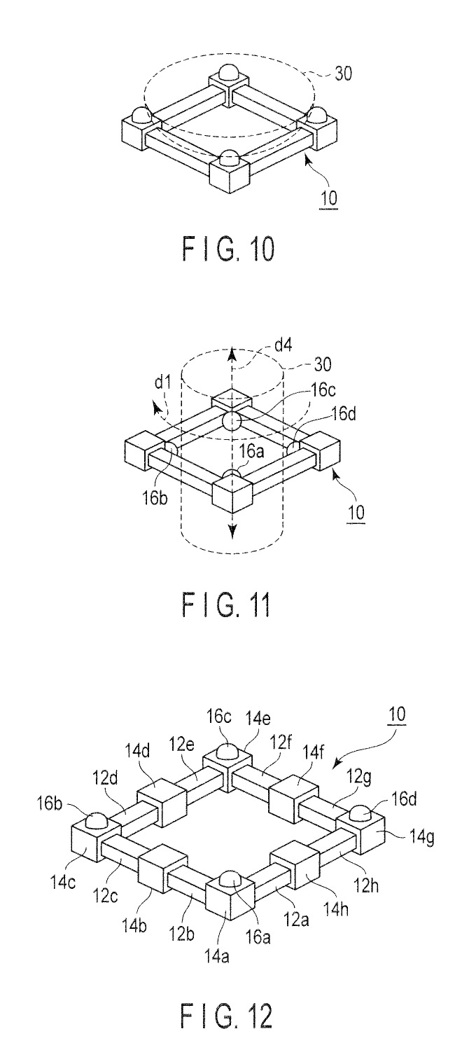

Note that the shape of the driven member 30 is not limited to the planar shape shown in FIG. 9. That is, the driven member 30 may be configured to allow contact with the friction members 16a, 16b, 16c, and 16d. It is therefore possible to form the driven member 30 into, for example, a shape having a curved surface like that shown in FIG. 10.

In the example shown in FIG. 11, four friction members 16a, 16b, 16c, and 16d are provided inside the transducer 10. The driven member 30 is formed as a cylindrical member which is inserted into the transducer 10 so as to be in contact with the friction members 16a, 16b, 16c, and 16d. The direction indicated by an arrow d1 in FIG. 11 is the driving direction of the driven member 30 based on <<Driving Method 1>> described above (the direction of driving by elliptic vibration around the z-axis). The direction indicated by an arrow d4 in FIG. 11 is the driving direction of the driven member 30 based on <<Driving Method 4>> described above (the direction of driving by elliptic vibration in a plane satisfying x=y).

Note that the numbers of piezoelectric bodies and coupling members which constitute the transducer 10 are arbitrary. It is therefore possible to further increase the driving force by making the transducer 10 include eight piezoelectric bodies 12a, 12b, 12c, 12d, 12e, 12f, 12g, and 12h, as shown in FIG. 12. This arrangement includes eight coupling members 14a, 14b, 14c, 14d, 14e, 14f, 14g, and 14h as coupling members so as to make the transducer 10 have a hollow square shape as a whole when viewed from above.

When forming ultrasonic motors using the transducers in the forms shown in FIGS. 9, 10, 11, and 12, it is possible to drive them by referring to <<Driving Method 1>> to <<Driving Method 4>>, as needed.

The above embodiments include inventions of various stages, and various inventions can be extracted by proper combinations of a plurality of disclosed constituent elements. When, for example, the problem described in “Description of the Related Art” can be solved and the effects described in “BRIEF SUMMARY OF THE INVENTION” can be obtained even if several constituent elements are omitted from all the constituent elements in each embodiment, the arrangement from which these constituent elements are omitted can be extracted as an invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A transducer comprising:
a first transducer member including a piezoelectric element in which longitudinal vibration and bending vibration are excited by application of a predetermined alternating signal;
a second transducer member which is placed to make a predetermined angle with the first transducer member and in which longitudinal vibration and bending vibration are excited by application of a predetermined alternating signal; and
a coupling member configured to hold one end of the first transducer member and one end of the second transducer member.

2. The transducer according to claim 1, wherein the first transducer member includes two electrically activated regions which are arranged side by side in a direction perpendicular to a first center axis connecting a center of an end face of the one end held by the coupling member and a center of an end face of the other end, and
the second transducer member includes two electrically activated regions which are arranged side by side in a direction perpendicular to a second center axis connecting a center of an end face of the one end held by the coupling member and a center of an end face of the other end.

3. The transducer according to claim 1, wherein the first transducer member includes two electrically activated regions which are arranged side by side in a direction along a first center axis connecting a center of an end face of the one end held by the coupling member and a center of an end face of the other end, and
the second transducer member includes two electrically activated regions which are arranged side by side in a direction along a second center axis connecting a center of an end face of the one end held by the coupling member and a center of an end face of the other end.

4. The transducer according to claim 2, wherein each of the first transducer member and the second transducer member includes two transducer members bonded each other, and
the two electrically activated regions are provided on each of the two transducer members.

5. The transducer according to claim 3, wherein each of the first transducer member and the second transducer member includes two transducer members bonded each other, and
the two electrically activated regions are provided on each of the two transducer members.

6. The transducer according to claim 2, wherein each of the first transducer member and the second transducer member is formed by stacking a plurality piezoelectric elements on each of which two electrodes are provided, and
the two electrically activated regions comprises the two electrodes provided on each of the plurality of piezoelectric elements.

7. The transducer according to claim 3, wherein each of the first transducer member and the second transducer member is formed by stacking a plurality of piezoelectric elements on each of which two electrodes are provided, and
the two electrically activated regions comprises the two electrodes provided on each of the plurality of piezoelectric elements.

8. An ultrasonic motor which frictionally drives a driven member by a frictional member provided on a transducer using elliptic vibration excited in the transducer as a driving source,
the transducer comprising
a first transducer member including a piezoelectric element in which longitudinal vibration and bending vibration are excited by application of a predetermined alternating signal,
a second transducer member which is placed to make a predetermined angle with the first transducer member and in which longitudinal vibration and bending vibration are excited by application of a predetermined alternating signal,
a coupling member configured to hold one end of the first transducer member and one end of the second transducer member, and
a fixing member configured to fix the other end of at least one of the first transducer member and the second transducer member.

9. The motor according to claim 8, wherein the plurality of transducer members are coupled to each other to form one transducer.
